(19) United States
(12) Patent Application Publication
(10) Pub. No.: US 2026/0344704 A1
(43) Pub. Date: Nov. 5, 2026

(54) USING LIBERATED AND MODIFIED FIBERS, MICRO-FIBERS, NANO-FIBERS, AND CELLULOSE FROM LIGNOCELLULOSIC PLANT FIBERS, COMBINED WITH ALGAE, AS FEED BINDERS IN COMPOUND FEEDS

(71) Applicants: Auburn University, Auburn, AL (US); THE UNITED STATES OF AMERICA, AS REPRESENTED BY THE SECRETARY OF AGRICULTURE, Beltsville, MD (US)

(72) Inventors: Burak Aksoy, Auburn, AL (US); Zhihua Jiang, Auburn, AL (US); Mediha Aksoy, Auburn, AL (US); Benjamin Beck, Auburn, AL (US)

(73) Assignees: Auburn University, Auburn, AL (US); THE UNITED STATES OF AMERICA, AS REPRESENTED BY THE SECRETARY OF AGRICULTURE, Beltsville, MD (US)

(21) Appl. No.: 18/997,689

(22) PCT Filed: Jul. 21, 2023
(86) PCT No.: PCT/US2023/028363

§ 371 Date: Jan. 22, 2025

Related U.S. Application Data
(60) Provisional application No. 63/391,531, filed on Jul. 22, 2022.

(51) Int. Cl. A23K 10/32; A23K 10/37; A23K 10/38; A23K 40/25; A23K 50/80; C08H 8/00

(52) U.S. Cl. CPC A23K 10/32; A23K 10/37; A23K 10/38; A23K 40/25; A23K 50/80; C08H 8/00

(57) ABSTRACT

Animal feed binders made from defibrillated lignocellulosic fibers, animal feeds comprising the defibrillated lignocellulosic fibers, and methods to make animal feeds using the defibrillated lignocellulosic fibers.

### CROSS-REFERENCE TO RELATED APPLICATIONS

The present application is the U.S. National Stage application of International Application No. PCT/US2023/028363, filed Jul. 21, 2023, which International Application was published on Jan. 24, 2024, as International Publication No. WO2024/020203. The International Application claims priority to U.S. provisional application Ser. No. 63/391,531, filed Jul. 22, 2022, the contents of which are incorporated herein by reference in their entireties.

### BACKGROUND

Manufactured animal feeds are a staple product of commerce. A host of natural products, such as wheat gluten, high-gluten wheat flour, and other starch-rich ingredients (rice, sorghum, corn, etc.) are used as binders in animal feeds (e.g., feeds for ungulates and swine, poultry feeds, fish feeds, shrimp feeds, feeds for domestic pets such as cats and dogs, etc.). Modified substances such as carboxymethyl cellulose, alginate, propylene glycol alginate and lignin sulfonate, as well as synthetic binders such as sodium or calcium bentonite, polyvinyl alcohol, and urea formaldehyde have also been used as binders. They vary widely in cost, performance, and beneficial vs. adverse impacts on animal health.

For example, extrusion cooking devices have long been used to make a wide variety of dry animal feeds, such dry dog food, cat food, and poultry feeds. The basic process is very straightforward conceptually, but much more complex in practice. The food material to be processed is passed through a temperature-controlled extruder barrel where it is subjected to increasing levels of temperature, pressure, and shear. As the material emerges from the extruder die, it is fully cooked and shaped. The conventional practice is to subdivide the product into pellets as it exits the extruder using a rotating knife assembly. See, for example. U.S. Pat. No. 10,383,347, issued Aug. 20, 2019, which describes an extruded animal feed that comprises a gelatin binder and a low starch content.

Animal feeds made via extrusion (as well as via other methods) typically include a binder to improve internal cohesive strength of the extruded, pelleted product. The binder provides a host of functional advantages to the final product. Most notably, the binder brings the food portions of the feed ration together so that the final product can be readily ingested by the target animal. At the same time, it makes the pelleted or agglomerated final product less likely to fracture during shipment, storage, and dispensing. This greatly cuts down on the creation of dust and fines, which leads to waste. In the context of extruded feeds, starches and modified starches are widely used as binders because they gelatinize under the conditions typically encountered during extrusion, which helps adhere the food components to one another.

As a general proposition, animal feeds are produced with low-cost, by-product food ingredients that cannot be sold in the human food market. The conventional, low-cost binders, though, do not yield feed pellets that are sufficiently durable. In addition to starch, mentioned above, various protein colloids, carboxymethyl cellulose, lignosulfonate-starch blends, and urea formaldehyde resins have been used as animal feed binders. U.S. Pat. No. 5,714,184, issued Feb. 3, 1998, even describes a method and composition of matter that uses sodium carbonate pulping liquor (from papermaking) as a pellet binder for animal feed.

See also U.S. Pat. No. 4,996,065, issued Feb. 26, 1991, which describes a molasses-free, chemically reactive binder for animal feed.

U.S. Pat. No. 4,988,520, issued Jan. 29, 1991, describes a binder comprising water-soluble calcium compounds, such as calcium hydroxide, calcium oxide, calcium chloride, and calcium acetate.

U.S. Pat. No. 4,952,415, issued Aug. 28, 1990, describes an animal feed composition that uses a polymer made from carboxylic acid-containing monomers as a binder, for example polymers made from polyacrylic acid, polymaleic acid, and polymethacrylic acid.

U.S. Pat. No. 4,153,735, issued May 8, 1979, describes a binder that contains a salt of a fatty acid, a hydrogenated lipid, and a water-soluble anionic polymer.

While some of these products do provide some improvement in pellet quality, there is much room for improvement.

### SUMMARY OF THE INVENTION

Disclosed herein is a method of using microfibrillated, liberated, and/or modified lignocellulosic fibers, micro-lignocellulosic fibers, nano-lignocellulosic fibers, and/or cellulose in small amounts (about 3 wt % or less) as feed binders in compound feed formulations. Also disclosed herein are the resulting feed compositions. The lignocellulosic materials for use in the binders can be derived from wood and woody biomass such as forest residues and/or non-wood derived lignocellulosic material, including, but not limited to, agricultural residues and biomass such as (but not limited to) wheat straw, corn straw and stalks, miscanthus, soybean hull (SBH), oat hull, peanut hull, cotton seed hull, rice hull, straw pulp, hemp fiber, distillers dried grains with solubles (DDGS), bagasse pulp, and cellulose-containing matter such as algae.

Lignocellulosic feedstock is processed to produce microfibrillated material, fibers, micro and nano fibers and/or cellulose products, and these products are added into compound feed in small amounts (preferably 0.1 to 3% weight/weight) to function as binders. (Amounts above and below this range are explicitly within the scope of the invention.)

This novel class of feed binder is produced inexpensively with minimal processing steps. The lignocellulose fiber-based binders disclosed herein improve both the dry and wet structural integrity of the compound feeds containing the binder(s).

It was hypothesized that undissolved plant fibers would improve pellet binding through entangling, interlocking and folding between different particles or strands of fiber. However, unprocessed cellulosic fibers are stiff and have high resilience, which reduces the effective contact between feed particles and the cellulosic fibers. Additionally, larger fibers it was thought would induce weak spots in the pellets due to increased inhomogeneity, which might give rise to breaking points within the feed pellets. As described herein, microfibrillation greatly increases the flexibility of the fibers, along with reducing their size. The smaller, more flexible fibers make excellent feed binders.

Thus, disclosed herein is an animal feed binder. The animal feed binder comprises microfibrillated lignocellulose-containing fibers. The microfibrillated lignocellulose-containing fibers may be derived from biomass. For example (and without limitation), the microfibrillated lignocellulose-containing fibers may be derived from a material selected from the group consisting of wheat straw, corn straw and corn stalks, miscanthus, soybean hull, oat hull, peanut hull, cotton seed hull, rice hull, straw pulp, hemp fiber, distillers dried grains with solubles, bagasse pulp, and algae. The microfibrillated lignocellulose-containing fibers can be produced by suspending a lignocellulose-containing feedstock in an aqueous medium to yield a suspension and then passing the suspension through a particle size reducer or homogenizer to microfibrillate the lignocellulose-containing feedstock.

In some versions of the binder, the lignocellulose-containing feedstock is optionally treated with an acid or a base, or treated with hot water, or treated with steam, or treated with an enzyme prior to passing the suspension through the particle size reducer or homogenizer.

In another version, the lignocellulose-containing feedstock or the microfibrillated lignocellulose-containing fibers are optionally bleached, either with or without being treated with acid or base.

In some versions of the binder, the suspension is passed through a particle size reducer or homogenizer at least 5 times, in another version at least 10 times.

Also disclosed herein is animal feed composition comprising a base feed ration and an animal feed binder comprising the microfibrillated lignocellulose-containing fibers as described herein.

Also disclosed herein is a method of making an animal feed composition. The method comprising microfibrillating a lignocellulose-containing feedstock to yield microfibrillated lignocellulose-containing fibers; and combining the defibrillated lignocellulose-containing fibers with a base feed ration. As noted above, the lignocellulose-containing feedstock may comprise biomass, such as wheat straw, corn straw and corn stalks, miscanthus, soybean hull, oat hull, peanut hull, cotton seed hull, rice hull, straw pulp, hemp fiber, distillers dried grains with solubles, bagasse pulp, and algae.

The lignocellulose-containing feedstock is preferably microfibrillated by suspending the lignocellulose-containing feedstock in an aqueous medium to yield a suspension and passing the suspension through a particle size reducer or homogenizer to thereby microfibrillate the lignocellulose-containing feedstock. The lignocellulos-containing feedstock may optionally be treated with an acid or a base, or treated with hot water, or treated with steam, or treated with an enzyme, as described above. The lignocellulose-containing feedstock or the microfibrillated lignocellulose-containing fibers may optionally (or in the alternative) be bleached. In a preferred version, the defibrillated lignocellulose-containing fibers are combined with the base feed ration at a concentration ranging from 0.1 wt % to 3 wt % of the defibrillated lignocellulose-containing fibers, based on total weight of the composition.

### ABBREVIATIONS AND DEFINITIONS

All references to singular characteristics or limitations of the disclosed composition shall include the corresponding plural characteristic or limitation, and vice-versa, unless otherwise specified or clearly implied to the contrary by the context in which the reference is made. The indefinite articles “a” and “an” mean “one or more.” “Or” is used inclusively in the sense of “and/or.”

All combinations of method steps disclosed herein can be performed in any order, unless otherwise specified or clearly implied to the contrary by the context in which the referenced combination is made.

The method disclosed herein can comprise, consist of, or consist essentially of the essential elements and steps described herein, as well as any additional or optional ingredients, components, or limitations described herein or otherwise useful in formulating animal feeds.

“Acids” and “bases”: These terms are used in their common sense as understood by food chemists. Acids include, without limitation, mineral and organic acids. Common mineral acids include, without limitation, hydrochloric acid, sulfuric acid, nitric acid, and the like. Common organic acids include, without limitation, lactic acid, acetic acid, formic acid, citric acid, oxalic acid, uric acid, malic acid, etc. In the same fashion as “acid,” both mineral and organic bases may be used. Common strong mineral bases include lithium hydroxide, sodium hydroxide, potassium hydroxide, and the like. Common organic bases include ammonia, alkylamines (such as methyl amine), pyridine, imidazole, benzimidazole, and the like.

“Biomass”: The organic materials produced by plants and animals, such as cobs, husks, leaves, roots, seeds, shells, and stalks, as well as microbial and animal metabolic wastes (e.g., manure), without limitation. Common sources of biomass include (without limitation): (1) agricultural wastes, such as corn cobs and stalks, straw, seed hulls, sugarcane leavings, bagasse, nutshells, citrus peels, fruit and vegetable skins, egg shells, and manure from cattle, poultry, and hogs; (2) woody materials, such as wood or bark, sawdust, timber slash, and mill scrap; (3) municipal waste, such as waste paper and yard clippings; (4) energy crops, such as poplars, willows, switch grass, alfalfa, prairie bluestem, corn, soybean; and (5) coal, peat moss, and the like. The term “biomass-derived” refers to any reactant or material that can be fabricated from biomass by any means now known or developed in the future, including (without limitation) polysaccharides, monosaccharides, polyols, oxygenated hydrocarbons, sugars, starches, and the like.

“Nano-fibers” are fibers having diameters in the nanometer range, that is from between about 1 nm and less than 1 μm. “Micro-fibers” are fibers having diameters in the micrometer range, that is from 1 μm and less than 1 mm, preferably between 1 μm and about 500 μm, and more preferably still preferably between 1 μm and about 100 μm. “Micro-fibers” are fibers having diameters larger than 1 mm.

CMC=carboxymethylcellulose. CS=corn starch, DDGS=dried distillers grains with solubles. SBH=soybean hulls. SDNF=saw dust micro-/nano-fibers. SHNF=soy hull micro-/nano-fibers. WG=wheat gluten. WSF=wheat straw fibers. WSFP=processed wheat straw fibers. WSNF=wheat straw micro-/nano-fibers.

### BRIEF DESCRIPTION OF DRAWINGS

FIG. 1. Wet stability of basal diets with two test binders (soybean hull (SBH) and hardwood (HW) binders) and two control binders (corn starch (CS) and wheat gluten (WG)). Concentrations were 0.5 wt % for micro-fibrillated soybean hull and wood and 1 wt % for both control binders.

FIG. 2. Wet stability of basal diets with various binders. Control binders (3=wheat gluten; 4=carboxymethyl cellulose, 5=alginate, 6=corn starch); microfibrillated lignocellulosic biomass (1=softwood, 2=cotton seed hull, 7=hardwood, 8=wheat straw, 9=peanut hull, 10=distillers grains, 11=hemp fiber, 12=miscanthus, 13=sugar beet pulp, 14=soybean hull).

FIG. 3. Water absorption of basal diets with various binders. Control binders (3=wheat gluten, 4=carboxymethyl cellulose, 5=alginate; microfibrillated lignocellulosic biomass (1=softwood, 2=cotton seed hull, 7=hardwood, 8=wheat straw, 9=peanut hull, 10=distillers grains, 11=hemp fiber, 12=miscanthus, 13=sugar beet pulp, 14=soybean hull).

FIG. 4. Percent pellet recovery comparison of the diets with control binders (Diets 1-4) and diets with micro/nano binders (Diets 5-16), tested at 24 hours leaching period. Binder levels range from 0.5 to 1.0 wt %. Values are the mean of four replicate runs.

FIG. 5. Water absorption (g) per gram of diets with control binders (Diets 1-4) and diets with micro/nano binders (Diets 5-14), tested at five absorption points (15 min, 30 min, 1 h, 2 h, and 4 h at room temperature. Binder levels ranged from 0.5 to 1.0 wt %. Values are the mean of four replicate runs.

FIG. 6. Wet stability of basal diets with various binders. Control binders (CMC=carboxymethyl cellulose, CS=corn starch, and WG=wheat gluten); fiber-based binders (WSF=wheat straw fiber, WSFP=wheat straw fiber processed); and nanofiber-based binders (WSNF=wheat straw nanofiber, SHNF: soyhull nanofiber, and SDNF: sawdust nanofiber).

### DETAILED DESCRIPTION OF THE INVENTION

Newly developed and disclosed herein is a lignocellulose fiber-based feed binder that improves the dry and wet structural integrity of compound animal feeds (including feeds for humans). The binders disclosed herein reduce feed pellet degradation in both dry and moist environments and when the feed is dropped into water (as is the normal course, for example, with fish feed). The binder comprises lignocellulosic fibers. The structural integrity of compound feeds in moist and dry environments, as well as when submersed in water, is important to maximize feed efficiency and to improve feed economy by reducing feed waste during production, packaging, handling, transportation, and use. The binder is highly cost-effective because lignocellulosic plants are abundant and economically available for conversion to macro-fibers, micro-fibers, nano-fibers and/or cellulose.

Natural products such as wheat gluten, high-gluten wheat flour, and other starch-rich ingredients (rice, sorghum, corn, etc.) are among the most commonly used binders in animal and aquatic organism feed, for example, shrimp feed. Modified substances such as carboxymethyl cellulose, alginate, propylene glycol alginate and lignin sulfonate and synthetic binders such as sodium or calcium bentonite, polyvinyl alcohol, and urea-formaldehyde have also been used as feed binders. But these modified substances tend to be costly, making them economically infeasible. Some of these modified types of binders adversely impact the growth of animals, and thus are not ideal (even if the resulting feed is mechanically robust).

### Producing and Processing of the Lignocellulosic Macro-Fibers, Micro-Fibers, Nano-Fibers, and Cellulose:

To produce wheat straw fibers (WSF), wheat straw was cut into 1- to 3-inch lengths and processed using a conventional soda pulping method. NaOH was used as the pulping chemical at temperatures ranging from 90 °C to 170 °C for 30 to 150 minutes. The resulting wheat straw pulp contained from about 3% to about 24% lignin. The fibers after washing and screening can be used as feed binders without further processing or they can be further processed. Wheat straw fibers were further processed by mechanically treating the fibers in a Valley-type beater for 60 minutes. Enough samples were taken from beaten wheat straw to be used as processed wheat straw fibers (WSFP) in the compound feed. Wheat straw micro/nano fibers were produced by passing the Valley beater-treated fibers through microfluidizer chambers (two chambers with 200 μm and 87 μm diameters) 10× in aqueous medium (WSNF). Applied pressure in the microfluidizer chambers was 20,000 psi.

Saw dust nanofibers were produced by first treating the saw dust in an alkaline aqueous medium, e.g., NaOH, at an elevated temperature for between about 30 to about 120 minutes. After drying, the material was ground using a laboratory size hammermill. The ground material was dispersed in water and passed through the microfluidizer chambers (two chambers with 200 μm and 87 μm diameters) for 10 passes (SDNF). Again, applied pressure in the microfluidizer chambers was 20,000 psi.

Soy hull nanocellulose was produced by first treating ground soybean hulls in aqueous medium with acid, e.g., HCl, at elevated temperatures for about 30 to about 120 minutes. The treated material was not washed or screened, but rather fully utilized with its dissolved solids. The treated material in aqueous medium was homogenized in a blender for 30 minutes and neutralized to pH 7. Finally, the material was passed through a Masuko Supermasscolloider-brand particle size reducer for 20 passes to produce micro-/nano-soy hull fibers (SHNF).

The purpose of pulping is to separate individual fibers from other non-fibrous components of wood and other plant material, notably lignin, an organic material that binds cellulose fibers together. Fiber production from wood species and other plants can be done by mechanical and chemical means or in other combinations of mechanical and/or chemical methods (e.g., semi-chemical pulping). Chemical pulping involves the use of water and/or chemicals in aqueous medium such as sodium hydroxide or sodium sulfide at elevated temperatures to dissolve some or most of the lignin from the plant matter. In mechanical pulping, size-reduction machines such as mills, refiner plates, or stones are used to fiberize the lignocellulosic plant matter. Semi-chemical pulping involves mild cooking in (most commonly) sodium sulfite combined with a small quantity of alkaline salts, such as sodium carbonate, sodium bicarbonate, or sodium hydroxide. The cooked plant materials are then sandwiched in refiner plates that separate the individual fibers. Further processing may optionally include bleaching to increase the cellulose content of the fibers, followed by fiber size reduction and fibrillation to micro or nano level. Bleaching chemicals such as chlorine dioxide, sodium hypochlorite, or hydrogen peroxide are used at elevated temperatures and alkaline pH values at reaction times between 15 minutes and 120 minutes. If a high cellulose content in the fiber is not needed or desired, fiber bleaching can be omitted.

Microfibrillation of the fibers then yields the binders disclosed herein. Many methods are available to reduce fiber size and to fibrillate the fibers to produce micro- and nano-fibers and/or cellulose. These methods include (but are not limited to) milling, passing the fibers through mechanical particle size reducers, homogenizers, cryo-crushing, ultrasonication, and the like.

### Example 1

Here, two feedstocks were used as source of lignocellulose: soybean hull and hard-wood saw dust. These were processed with a Masuko “Supermasscolloider”-brand particle size reducer (Masuko Sangyo Co., Ltd., Kawaguchi, Japan) or a “Microfluidizer”®-brand particle size reducer (Microfluidics Corporation, Newton, Massachusetts, USA) at 4% (w/w) consistency in water and 20,000 psi. The bulk feedstock was passed through the particle size reducer 10 times. The resulting processed lignocellulose was incorporated at 0.5 wt % into conventional shrimp feed pellets. The resulting feed pellets were then tested for water stability.

The shrimp feed was prepared as follows: A basal practical shrimp diet was formulated to contain approximately 41.6% crude protein and 7.6% lipid. See Table 1 for the complete recipe. After mixing the dry ingredients for 10 min in a Hobart mixer, oil, binders and deionized water at roughly 300 ml liquid per kg of the diet was added. The moist mixture was extruded through a 2.5 mm diameter die in a Hobart meat grinder. The resulting moist pellets were air-dried at room temperature to a moisture content of about 10%.

TABLE 1
Percent composition of experimental basal diet.

| | (wt %) |
|---|---|
| Menhaden fish meal | 20 |
| Squid meal | 12 |
| Soybean meal | 28 |
| Cottonseed meal | 8 |
| Wheat short | 10 |
| Whole corn meal | 10 |
| Fish oil | 3.3 |
| Soy lecithin | 1 |
| Cholesterol | 0.2 |
| Dicalcium Phosphate | 1 |
| Potassium Phosphate | 1 |
| Binders¹ | 2 |
| Vitamin premix² | 1 |
| Mineral premix³ | 0.5 |
| Celufil | 2 |

¹Binders for diets 1, 2, 3, 4, 5 and 6 contained 2 wt % carboxymethyl cellulose (CMC), corn starch (CS), wheat gluten (WG), fully utilized soy hull (fibers and the extract) after acid extraction process (Diet 4), acid extract (Diet 5) and combination of acid and alkali extracts (Diet 6).
²Vitamin premix, diluted in cellulose, provided the following vitamins (mg/kg diet): vitamin A (520,400 IU/g), 5.8; vitamin D3 (108,300 IU/g), 18.5; vitamin E (250 IU/g), 1200; vitamin K, 10; thiamin, 80; riboflavin, 60; pyridoxine, 70; calcium pantothenate, 150; nicotinic acid, 100; folic acid, 20; vitamin B12, 0.4; biotin, 2; choline chloride, 1500; and L-ascorbyl-2- polyphosphate (35% vitamin C activity), 500.
³Trace mineral premix provided the following minerals (mg/kg diet): zinc (as ZnSO₄•7H₂O), 100; iron (as FeSO₄•7H₂O), 40; manganese (as MnSO₄•7H₂O), 5; copper (as CuCl₂), 10; iodine (as KI), 4; cobalt (a COCl₂•6H₂O), 0.04; selenium (as Na₂SeO₃), 0.1; magnesium (as MgSO₄•7H₂O), 130; sodium (as NaH₂PO₄), 15; and calcium (as CaCO₃), 100.

### Dry Stability Test:

Dry stability testing measures the degree of powder or dust found in each of the diets after extruding and the grinding the feed to an appropriate pellet size. Dry strength was evaluated by weighing 500 g of each feed sample (in the form of extruded “spaghetti”), grinding the feed “spaghetti” into small pieces with a feed grinder, and then sieving to separate broken pellets from dust. Recovered pellets and dust were weighed and the proportion of feed loss was then calculated. Results are shown in Table 2. Experimental diets were stored frozen in plastic bags at −20 °C until used. As shown in Table 2, diets using the microfibrillated binders described herein had similar or slightly improved dry strength than that of the diets using control binders

TABLE 2
Dry strength of the basal diet pellets with various binders

(%)

| | pellet | dust |
|---|---|---|
| CMC | 70.96 | 28.66 |
| CS | 74.38 | 25.54 |
| WG | 74.54 | 25.38 |
| WSF-2% | 75.52 | 24.24 |
| WSFP-2% | 75.84 | 23.92 |
| WSNF-0.75% | 73.76 | 25.82 |
| SHNF-1% | 72.58 | 27.22 |
| SDNF-2% | 75.20 | 24.20 |

### Water Stability of Pelleted Feeds:

The water stability of pellets was determined following immersion for a 24-hour period at a water temperature of 30 °C Sieves (15-cm diameter×5 cm height and 1.5-mm mesh screen) were thoroughly washed, dried in an oven at 80 °C and weighed. Five (5) g of feed pellets (pre-dried at 80 °C) were placed into the sieves and lowered into an aquarium. The aquarium was filled with well water to a level just below the rim of the sieve. The salinity of the water was adjusted to 23 ppt. The pellets were gently but continuously agitated by an air stone directly under the sieve. After each period, the sieves were gently removed from the water, tipped slightly to drain the water, and dried in the oven at 80 °C for 24 hours, then cooled in a desiccator and weighed. Each sample for each time point was run in quadruplicate. The proportion of feed loss was calculated based on the starting weight of 5 g/sample minus the final weight of each sample.

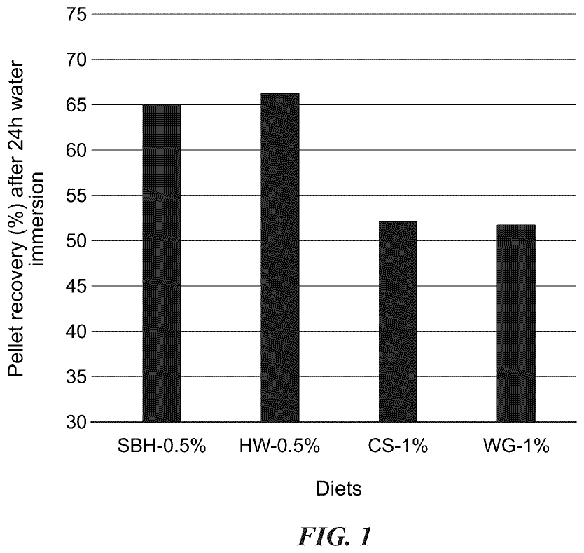

The feed pellets that contained microfibrillated soybean hull and hardwood performed better than the control binders of corn starch and wheat gluten even though their addition levels were half that of the control binders in terms of wet stability of the feeds after 24 hours of water immersion. See FIG. 1.

### Example 2

After the promising preliminary results, ten (10) different lignocellulosic biomass feedstocks (microfibrillated softwood, cotton seed, hardwood, wheat straw, peanut hull, distiller grains from com, hemp, miscanthus, sugar beet and soybean hull) were selected and compared with four natural feed binders (wheat gluten, carboxymethyl cellulose, alginate, and corn starch) for feed water stability after different water immersion times and for water absorption. A Masuko Supergrinder-brand particle size reducer was used in the microfibrillation process at a consistency of 4%. The biomass samples were not processed in any other way beyond the microfibrillation. Microfibrillation processing was stopped as soon as the material showed gel properties. The number of passes to achieve this result was between 6 and 7 for each feedstock sample. In the preparation of feed pellets and water stability testing, the same protocol was performed as described in Example 1. The pellet water absorption tests were executed according to the following procedure: Dry feed pellets were weighed (2 g) and soaked in a 50 ml centrifuge tube filled with 40 ml well water previously adjusted to 23 ppt salinity. Samples were kept in the water at room temperature for 15 minutes, 30 minutes, and 1, 2, and 4 hours, without shaking. Individual tubes were used for each soaking time. At the end of each soaking time, the feed pellets were poured through an 8-mesh screen. Excess free water was blotted with paper towel and the sample so treated was weighed. Pellet water absorption was determined from the difference in weight between the wet and dry samples.

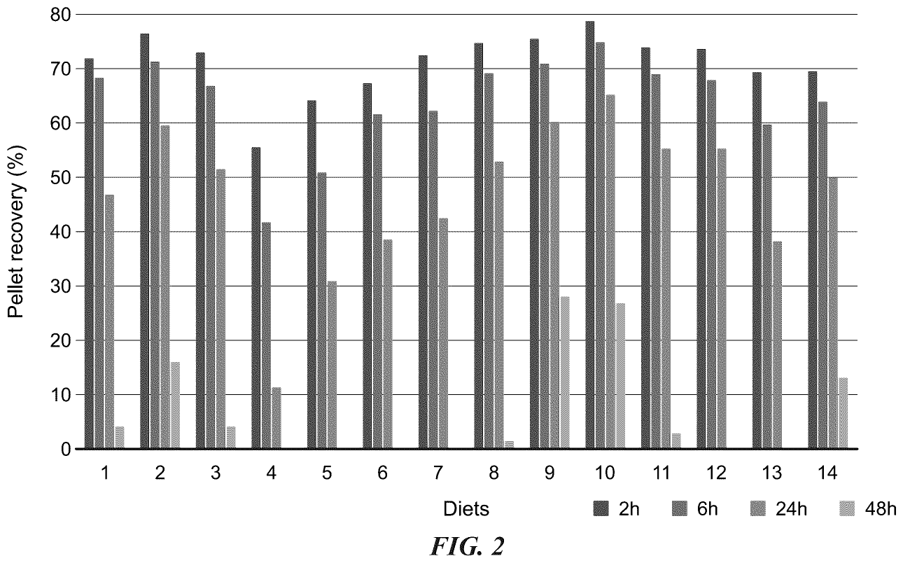

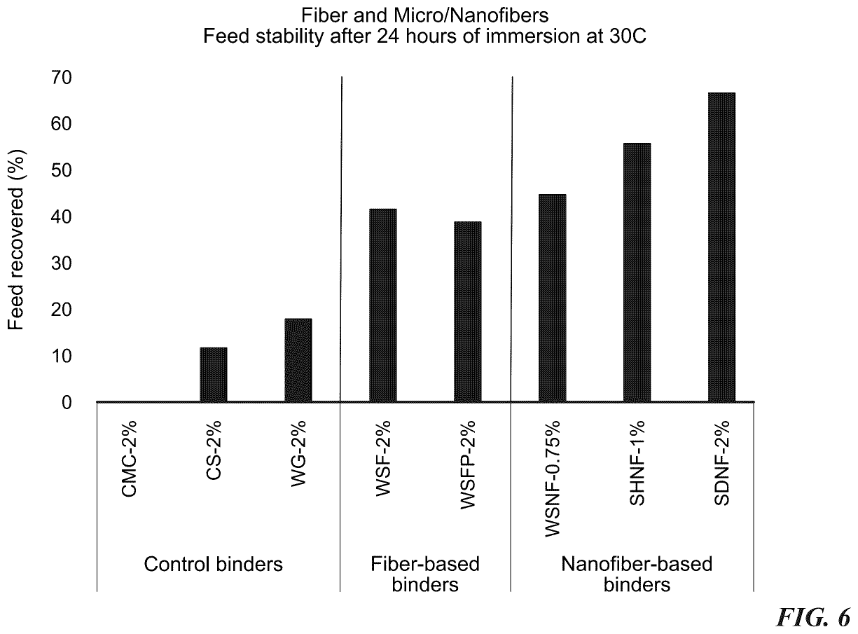

The results are shown in FIGS. 2 and 6. As can be seen from FIGS. 2 and 6, the microfibrillated lignocellulosic biomass samples (1=softwood, 2=cotton seed hull, 7=hardwood, 8=wheat straw, 9=peanut hull, 10=distillers grains, 11=hemp fiber, 12=miscanthus, 13=sugar beet pulp, 14=soybean hull) performed better than most of the control binders (3=wheat gluten; 4=carboxymethyl cellulose, 5=alginate, 6=corn starch). At every time point tested, the control binders corn starch, carboxymethyl cellulose, and alginate were inferior to the samples tested from the ten microfibrillated lignocellulosic feedstocks (Diets 1, 2, and 7-14). Only wheat gluten as the control binder (Diet 3) performed similarly to a select few of the microfibrillated lignocellulosic biomass samples (softwood (1), hardwood (7), sugar beet pulp (13), and soybean hull (14)). But the wheat gluten binder was still inferior to all the other microfibrillated lignocellulosic biomass samples (i.e., wheat straw (8), peanut hull (9), distiller's grains (10), hemp fiber (11), and miscanthus (12)). Feed pellets were recovered in significant quantities even after 48 hours of water soaking with feed pellets containing microfibrillated peanut hulls, distiller grains, cottonseed hulls, and soybean hulls as binders.

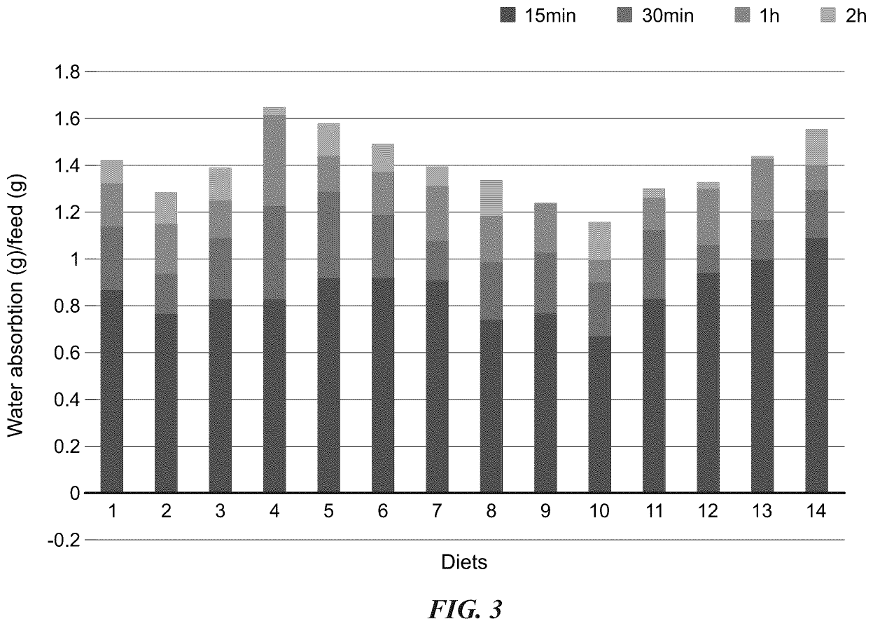

The amount of water absorbed by each test diet at each time point is presented in FIG. 3. Mirroring the results from FIG. 2, the pellets from diets containing microfibrillated lignocellulose had improved wet strength as compared to controls (FIG. 2) and the lower water absorption values as compared to controls (FIG. 3).

### Example 3

The amount of water absorbed by lignocellulosic fibers is directly influenced by the level of treatment they received. Water absorption is also influenced by properties intrinsic to the fibers themselves, such as morphology. Every additional cycle of extraction, pulping and bleaching of the lignocellulose step leads to fibers with higher cellulose. The higher cellulose content of the fibers yields higher water absorption. As shown in FIGS. 2 and 3, there is strong negative correlation between feed binding strength and water absorption. Thus, lignocellulosic biomass feedstocks don't require any further processing steps beyond the microfibrillation described herein to yield feed binders having much improved for binding strength. Nevertheless, the effect of multiple cycles of extracting, pulping, and bleaching of the microfibrillated lignocellulosics on the binding strength and water absorption of the selected microfibrillated fibers was also studied.

Fully utilized lignocelulosic fibers, bleached and unbleached forms of micro/nano fibrillated samples with a total of 12 samples at varying levels of particle size reduction were tested for their binding properties in shrimp feed pellets against the four control binders noted for Example 2. Samples were added in the feed pellets in between 0.5 and 1% dry weight/weight basis. The feed pellets were then tested for water absorption and water stability properties as described earlier.

### Diets (Binders Used; Notes)

Diet 1=Control-1: no binder
Diet 2=Control-2: corn starch, 1% in the diet
Diet 3=Control-3: wheat gluten, 1% in the diet
Diet 4=Control-4: sodium alginate, 1% in the diet
Diet 5=Unbleached miscanthus micro/nano fibrillated, 1% in the diet
Diet 6=Unbleached soft wood micro/nano fibrillated, 1% in the diet
Diet 7=Unbleached wheat straw micro/nano fibrillated, 1% in the diet
Diet 8=Hemp fiber micro/nano fibrillated, 1% in the diet
Diet 9=Soybean Hull-Full, CT* micro/nano fibrillated (Masuka Supergrinder), 1% in the diet
Diet 10=Soybean hull washed* * micro/nano fibrillated, 1% in the diet
Diet 11=Bleached soybean hull micro/nano fibrillated, 1% in the diet
Diet 12=Bleached soft wood micro/nano fibrillated, 0.7% in the diet,
Diet 13=Wheat straw micro/nano fibrillated (Microfluidizer®-brand), 0.75% in the diet
Diet 14=Soybean hull, Full, CT, micro/nano fibrillated (Microfluidizer®-brand),

1% in the diet
Diet 15=Soybean Hull-Full NCT** micro/nano fibrillated-0.5% in the diet.
Diet 16=Saw dust (hardwood)-Full NCT micro/nano fibrillated-0.5% in the diet.

*CT=chemically treated.

** After the chemical (acid) (acid) treatment, the resulting soybean hull was washed

with DI water followed by centrifugation (or filtration) three times to remove free dissolved compounds.

**NCT: No Chemical Treatment.

Diets that utilized the wood and/or lignocellulosic biomass entirely are Diets 9 and 14-16

### Results

All the microfibrillated lignocellulosic biomass samples performed on par with or better to the four control binders for water stability after soaking the pellets in water for 24 hours. However, the more the chemical processing the fibers received including pulping and bleaching the poorer the water stability performance of the pellets. The result was likewise reflected in the higher water absorption properties of these same Diets (with only exception being the soybean hull binder).

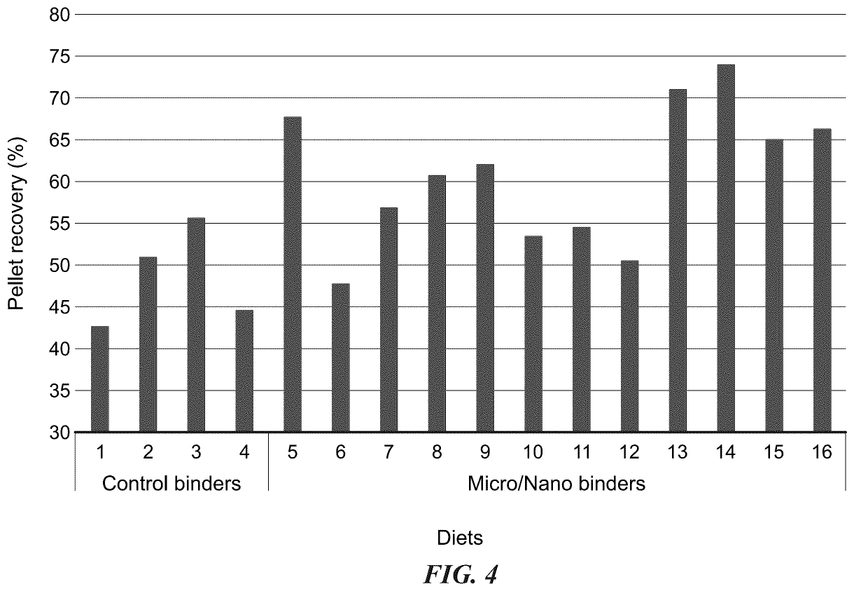

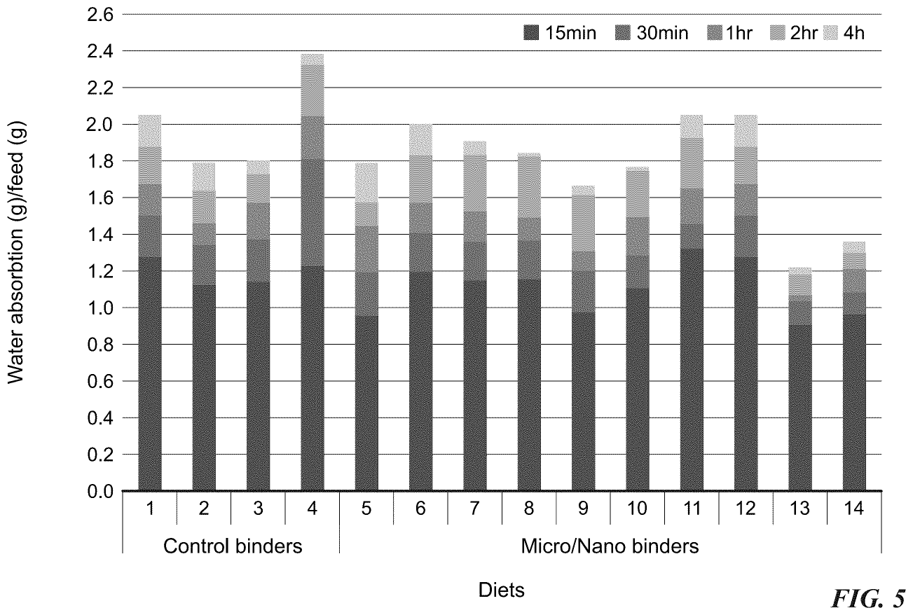

Feed pellets with the fully utilized micro/nano fibrillated soybean hull with chemical treatment and unbleached wheat straw micro/nano fibrillated samples (Diet 14-UB-WS) had the highest water stability (FIG. 4) and the lowest water absorption capacity (FIG. 5). Limited water absorption and swellability of these samples enabled feed pellets to perform very well in water. Fully utilized soybean hull that received only the nano/micro fibrillation process without any chemical treatment also performed very well as feed binder (Diet 15). Fully utilized wood without any chemical treatment (Diet 16) and unbleached miscanthus (Diet 5) also showed very strong binding properties in the feed pellets. Micro-/nano-fibrillated unbleached softwood kraft cellulose (Diet 6) and micro-/nano-fibrillated bleached kraft cellulose (Diet 12) were the lowest performing lignocellulosic fiber samples in terms of water stability and also had the highest water absorption. Even so, feed pellets with softwood kraft fiber samples (Diet 12) performed better than many of the control feed binders tested. The softwood kraft fiber feed pellets performed as well as other micro-/nano-fibrillated samples, particularly the unbleached miscanthus (Diet 5), wheat straw (Diet 13) soyhull (Diet 14) and wood (Diet 16) in water. This is thought to be due to the high swellability of kraft fibers. The water stability of pellets was inversely related to water absorption rate for all diets.

Diets 12 through 14 received higher level of fibrillation by the increased pass numbers at the Masuko or Microfluidizer. Feed pellets that received lesser fibrillation treatment, including unbleached miscanthus, hemp, wheat straw and bleached and unbleached soybean hull had relatively lower water absorbance and water stability than that of their counterparts that received higher level of fibrillation. However, all micro/nano samples (diets 5-11) performed equal or better water stability compared to some or all control binders (diets 1-4). Thus, increasing the level of fibrillation in the micro/nano level increases the water stability performance of lignocellulosic samples.

This result suggests that for better feed pellet binding properties, no additional chemical processing is needed and microfibrillation of the lignocellulosic alone is enough for best binding performance. Fully utilized lignocellulosic nano/micro fibrillated fibers are relatively inexpensive to produce and does not require the removal of any of the fiber compounds to efficiently perform as feed binder. Therefore, the best way to produce better performing feed binders from lignocellulosic fibers in an economical way is to utilize the fibers fully without removing any of its compounds from the final product and to fibrillate them to micro or nano level. However, various treatments including chemical (diet 9-soybean hull), hot water, steam, enzymatic, etc., can be applied to maximize the solubility and activation of the binding compounds in the lignocelllulosic feedstock (i.e., pectin, protein, lignin, hemicelluloses) before or after the micro/nano fibrillation process.

Diets 12 through 14 received a higher level of fibrillation due to being passed through the particle size reducer more times. Feed pellets that received lesser fibrillation/particle size reduction, including unbleached miscanthus, hemp, wheat straw and bleached and unbleached soybean hull had relatively lower water absorbance and water stability than that of their counterparts that received higher levels of fibrillation/particle size reduction. However, all micro-/nano-fiber samples (Diets 5-11) performed or par with or better in terms of water stability compared to most of the control binders (Diets 1-4). As a general rule, then, the data show that increasing the level of fibrillation increases the water stability performance of the samples that used the lignocellulosic micro-/nano-fiber binders.

Lignocellulosic plant feedstocks are widely available and inexpensive. The microfibrillation process itself is also inexpensive and easily scalable. The feed binders produced as disclosed herein markedly improve the structural integrity of the compound feed in water. This is a critically important factor in feeds for aquatic organisms. Minimizing disintegration of the feed pellets minimizes loss of nutrients upon exposure to water; the feed is utilized far more efficiently. Feed pellets with insufficient water stability quickly leach nutrients into the surrounding water. This results in several detriments. For example, it reduces the water quality of the culture environment, which leads to poor animal growth. It also causes insufficient/reduced feed conversion—which increases the cost of bringing the organisms to market weight. It also lowers the survival rate of the cultured organisms. The feed binders disclosed herein ameliorate all these concerns. The binders disclosed herein can be used in a wide range of compound feed products such as fish feed, crustaceans (shrimp, crab . . . etc.) feed, poultry feed, swine feed, dog and cat feeds, etc.

1. An animal feed binder comprising microfibrillated lignocellulose-containing fibers.

2. The animal feed binder of claim 1, wherein the microfibrillated lignocellulose-containing fibers are derived from biomass.

3. The animal feed binder of claim 1, wherein the microfibrillated lignocellulose-containing fibers are derived from a material selected from the group consisting of wheat straw, corn straw and corn stalks, miscanthus, soybean hull, oat hull, peanut hull, cotton seed hull, rice hull, straw pulp, hemp fiber, distillers dried grains with solubles, bagasse pulp, and algae.

4. The animal feed binder of claim 1, wherein the microfibrillated lignocellulose-containing fibers are produced by suspending a lignocellulose-containing feedstock in an aqueous medium to yield a suspension and passing the suspension through a particle size reducer or homogenizer to thereby microfibrillate the lignocellulose-containing feedstock.

5. The animal feed binder of claim 4, wherein the lignocellulose-containing feedstock is treated with an acid or a base prior to passing the suspension through the particle size reducer or homogenizer.

6. The animal feed binder of claim 4, wherein the lignocellulose-containing feedstock or the microfibrillated lignocellulose-containing fibers are bleached.

7. The animal feed binder of claim 4, wherein the suspension is passed through a particle size reducer or homogenizer at least 5 times.

8. The animal feed binder of claim 4, wherein the suspension is passed through a particle size reducer or homogenizer at least 10 times.

9. An animal feed composition comprising a base feed ration and an animal feed binder comprising microfibrillated lignocellulose-containing fibers.

10. The animal feed composition of claim 9, wherein the microfibrillated lignocellulose-containing fibers are derived from biomass.

11. The animal feed composition of claim 9, wherein the microfibrillated lignocellulose-containing fibers are derived from a material selected from the group consisting of wheat straw, corn straw and corn stalks, miscanthus, soybean hull, oat hull, peanut hull, cotton seed hull, rice hull, straw pulp, hemp fiber, distillers dried grains with solubles, bagasse pulp, and algae.

12. The animal feed composition of claim 9, wherein the microfibrillated lignocellulose-containing fibers are produced by suspending a lignocellulose-containing feedstock in an aqueous medium to yield a suspension and passing the suspension through a particle size reducer or homogenizer to thereby microfibrillate the lignocellulose-containing feedstock.

13. The animal feed composition of claim 12, wherein the lignocellulose-containing feedstock is treated with an acid or a base, or treated with hot water, or treated with steam, or treated with an enzyme prior to passing the suspension through the particle size reducer or homogenizer.

14. The animal feed composition of claim 12, wherein the lignocellulose-containing feedstock or the microfibrillated lignocellulose-containing fibers are bleached.

15. The animal feed composition of claim 9, wherein the binder is present in a concentration ranging from about 0.1 wt % to about 3 wt % based on total weight of the composition.

16. A method of making an animal feed composition, the method comprising:
(a) microfibrillating a lignocellulose-containing feedstock to yield microfibrillated lignocellulose-containing fibers; and
(b) combining the defibrillated lignocellulose-containing fibers with a base feed ration.

17. The method of claim 16, wherein the lignocellulose-containing feedstock comprises biomass.

18. The method of claim 16, wherein the lignocellulose-containing feedstock comprises a material selected from the group consisting of wheat straw, corn straw and corn stalks, miscanthus, soybean hull, oat hull, peanut hull, cotton seed hull, rice hull, straw pulp, hemp fiber, distillers dried grains with solubles, bagasse pulp, and algae.

19. The method of claim 16, wherein the lignocellulose-containing feedstock is microfibrillated by suspending the lignocellulose-containing feedstock in an aqueous medium to yield a suspension and passing the suspension through a particle size reducer or homogenizer to thereby microfibrillate the lignocellulose-containing feedstock.

20. The method of claim 16, wherein the lignocellulos-containing feedstock is treated with an acid or a base, or treated with hot water, or treated with steam, or treated with an enzyme prior to passing the suspension through the particle size reducer or homogenizer.

21. The method of claim 16, wherein the lignocellulose-containing feedstock or the microfibrillated lignocellulose-containing fibers are bleached.

22. The method of claim 16, wherein the defibrillated lignocellulose-containing fibers are combined with the base feed ration at a concentration ranging from 0.1 wt % to 3 wt % of the defibrillated lignocellulose-containing fibers, based on total weight of the composition.
